(19) United States
(12) Patent Application Publication
(10) Pub. No.: US 2016/0273821 A1
(43) Pub. Date: Sep. 22, 2016

(54) A MOBILE DEVICE FOR STORING AND COOLING FOOD OBJECTS

(71) Applicant: Joakim SCHÖLLIN, Ramnäs (SE)

(72) Inventor: Joakim Schöllin, Ramnäs (SE)

(21) Appl. No.: 14/442,278

(22) PCT Filed: Nov. 15, 2013
(86) PCT No.: PCT/EP2013/073917

§ 371 Date: May 12, 2015

(30) Foreign Application Priority Data
Nov. 19, 2012 (SE) 1251305-7

(51) Int. Cl. F25D 1/02; B65D 33/08; B65D 81/18; A47J 41/00; B65D 81/38

(52) U.S. Cl. CPC F25D 1/02; A47J 41/0066; A47J 41/0083; B65D 81/3888; B65D 81/18; B65D 33/08; F25D 2331/801

(57) ABSTRACT

The present invention relates to a mobile device for storing and cooling food objects, comprising a first bag (1) defining a first cavity configured to store at least one food object, and a second bag (2) attached to the first bag and defining a second cavity configured to store at least one weight for sinking the device below a water level, and the device is designed to enable a line to be connected to the device for securing the device when it is below the water level.

### FIELD OF THE INVENTION

The present invention relates to a mobile device for storing and cooling food objects. The present invention also relates to a method for storing and cooling at least one food object, and the use of the device for storing and cooling at least one food object.

### BACKGROUND OF THE INVENTION AND PRIOR ART

Many food objects, such as meat and milk, need to be stored at a low temperature to prevent these objects from decomposing too quickly. This imposes a problem when refrigerators cannot be used. A common solution used on camping sites is classical cooling boxes and bags, where the cavity of the box or bag is cooled electrically or by use of ice blocks and the like. During outdoor activities however, such as fishing and camping in the wild, such boxes are often not available or cannot be taken along due to their large volume and weight. Preventing food objects from going bad during such outdoor activities, especially at warm outer temperatures, is a problem.

It is known that cold water can be used to prevent food objects from decomposing. U.S. Pat. No. 2,350,883 discloses a method for storing goods to prevent them from decomposing over time by storing the goods into large containers under water for a long time. A weight is attached to the container for keeping them submerged. A line is used for connecting the container to a holding object such as a boat, a buoy or an object at shore.

However, no storage devices are available, which can efficiently and conveniently be used during outdoor activities. There is still a need for a more efficient and cost effective method to store and cool food objects during outdoor activities, when no refrigerator or cooling boxes can be used. There is a need for a storage device, which is small, low weight and easy to carry and handle during outdoor activities.

### OBJECT AND SUMMARY OF THE INVENTION

It is an object of the present invention to provide a device for storing and cooling food objects suitable for outdoor activities, such as fishing and camping.

This object is achieved by a mobile device as defined in claim 1.

The device comprises a first bag defining a first cavity configured to store at least one food object and a second bag attached to the first bag and defining a second cavity configured to store at least one weight for sinking the device below a water level, and the device is designed to enable a line to be attached to the device for securing the device when it is below the water level.

The device according to the invention is lightweight and can be folded or rolled into a small package when not used, which requires little space. Thus, the device is easy to carry when travelling on foot, in a canoe, or on a bicycle. The weight, which for example is a stone, can be put into the second bag just before the bag is to be immersed in the water. Thus, it is not necessary to carry the weight during the travel.

An advantage of the device according to the invention is that it comprises of a minimum of parts that are attached to each other, which improves convenience of use of the device during outdoor activities. The parts are attached to each other and can therefore be easily and quickly used without the need for assembling the device before use. The device is easy to manufacture at low cost.

The device comprises an opening or protrusion to enable a line to be attached to the device.

According to an embodiment of the invention, the first bag and the second bag are made of flexible material. Flexibility of the material improves convenience when inserting objects and weights into the outer bags. For packing the storage device, when it is not used, it is preferably folded or rolled into a small package. According to an embodiment of the invention, the first bag and the second bag are made of durable material. The durability is needed because the device may be pulled over stones and the like on the bottom of a sea or lake. Durability also improves the re-usability of the storage device.

According to an embodiment of the invention, at least the first bag is made of waterproof material. No inner bags may be needed if at least the first bag is made of waterproof material.

According to an embodiment of the invention, the device comprising a line configured to secure the storage device to a holding object, the line comprising a first securing member at a first end designed to be connected to the device and a second securing member at a second end for connecting to a holding element. The line can be used to lower the storage device at a certain depth in the water. It can also be used to drag the storage device behind a boat to cool the food objects during a boat ride.

In one embodiment, the first and second securing members comprise carbines adapted to be passed through a hole of the device. Carbines are easy to use, durable and relatively cheap. They are also available and easy to replace.

Preferably, the device comprises an element to allow a line to be connected to the device. The element is, for example, a hook or a hole.

According to an embodiment of the invention, the device comprises a hole configured to enable a line to be connected to the device. The presence of a hole to enable a line to be connected to the device provides an efficient way for connecting a line to the device for securing the device and prevents the device from drifting away in the water.

According to an embodiment of the invention, the device comprises a handle part having an upper side and a lower side and comprising a hole configured to enable a user to hold the storage device by a hand, the first bag has an upper side and a lower side, the lower side of the first bag is attached to the second bag, and the upper side of the first bag is attached to the lower side of the handle part. The handle provides for comfort of carrying and handling the device, especially when the device is filled with food objects and weights, the handle provides for an efficient way to carry the device. The handle may also prevent injuries due to lifting of the device in an uncomfortable way.

According to an embodiment of the invention, the hole configured to enable a line to be connected to the device is positioned in said handle part. The presence of a hole to enable a line to be connected to the device in the handle part improves the ease of use of the line and thus the storage device. When pulling the storage device out of the water, firstly the handle will raise above the water level. The storage device can than immediately be gripped by a user and pulled out of the water in a convenient way.

In one embodiment, the handle comprises a frame adapted for coiling the line around said frame. A frame can be provided as a stable handle, which is convenient to use. In another embodiment, the mobile storage device further comprises a frame positioned at the upper side of the handle and adapted for coiling the line around said frame. The frame can provide a dual purpose, one as a handle and one as a coiling device for coiling the line. When the device is not used it is practical to coil the line around a frame on the device so that the different part of the coiling device can held together. Coiling of the line on the frame makes it also possible to vary the length of the line and thereby varying the depth of the storage device in the water.

According to an embodiment of the invention, the first bag comprising a first opening for receiving the food object and a first locking member configured to seal the first bag. For example, the first locking member of the first outer bag comprises a zipper.

According to an embodiment of the invention, the second bag comprising a second opening for receiving the weight and a second locking member configured to seal the second outer bag. For example, the second locking member of the second outer bag comprises a zipper.

The locking members are preferably easy to use, especially under wet conditions. Zippers are easy to use, relatively cheap and durable.

In another embodiment, the first opening in the first bag and/or the second opening in the second bag extend parallel to an upper side of the first bag and/or second bag, respectively. In a further embodiment, the first and second openings of the first and second bags are positioned close to the upper side of the first and second front face, respectively. The openings are preferably positioned so that food objects and weights can be easily inserted into the first and second outer bags.

According to an embodiment of the invention, the cavity of said first bag is enclosed by a first front face and a first back face, whereby the first front face and the first back face have a first width and are connected by side faces that extend between a first upper side and a first lower side of the first bag, and said first opening is positioned on the first front face extending over a portion of the first width.

According to an embodiment of the invention, the cavity of said second bag is enclosed by a second front face and a second back face, whereby the second front face and the second back face have a second width and are connected by side faces that extend between a second upper side and a second lower side of the second bag, and said second opening is positioned on the second front face extending over a portion of the second width, whereby the first lower side of the first bag is attached to the second upper side of the second bag .

According to an embodiment of the invention, the first and second bags are removably attached to each other. It may be advantageous to be able to remove the second bag, for example, for packing the device during travelling. Also, in some circumstances the second outer bag may not be needed to sink to storage device under a water level because the weight of the food objects in the first outer bag may be heavy enough to submerge the storage device. In one embodiment, the attachment between the first bag and the second bag comprises a zipper. Zip-locks are convenient to use for to sealing plastic bags. They provide for a waterproof sealing of the bag and are light.

A permanent and firm attachment of the two outer bags minimized the risk of loosing a part of the storage device. It also reduces the need to reassemble the device before use and may also reduce the risk of wear. A permanent attachment may thus improve the quality of the storage device and the efficiency and convenience of using the storage device. In one embodiment the attachment is at least one seam. In a further embodiment, the upper side of the first outer bag is attached to the lower side of the handle by means of at least one seam.

According to an embodiment of the invention, the device comprises at least one waterproof inner bag for storing at least one food object and adapted to be inserted inside the first bag, whereby the inner bag comprises a locking member configured to seal the inner bag. An inner bag can be used to provide a waterproof sealing of at least one food objects. In one embodiment, one inner bag is used. In a further embodiment, the locking member of the inner bag and/or the isolation bag comprises a zip-lock.

In a further embodiment, the mobile storage device further comprises at least one isolation bag configured to cool at least one food object and adapted to be inserted inside the first bag. The isolation bag comprises a locking member configured to seal the isolation bag. During transport, e.g. to a camping site, food objects need to stay cool. For this purpose an isolation bag can be used. In one embodiment, the isolation bag is lined with aluminium to improve cooling of the food object. Ice blocks and the like may be inserted in the isolation bag to improve the cooling effect.

The object is also achieved according to a use of the mobile device according to the invention for storing and cooling at least one food object below the water level.

Furthermore, the object is achieved by a method for storing and cooling at least one food object by means of a storage device according to the invention, comprising the steps of

filling the first bag with at least one food object,

filling the second bag with at least one weight,

attaching a first end of a line to the storage device

sinking the storage device below the water level, and

attaching a second end of the line to a holding object.

The new method provides for an easy way to protect the freshness of food objects during outside activities when no other cooling means are available. The storage device is, for example, sunken at a depth of 0 to 25 meter below the water level.

### BRIEF DESCRIPTION OF THE DRAWINGS

The present invention is now to be explained more closely by means of embodiments, which are disclosed as examples, and with reference to the attached drawings.

FIG. 1. shows a storage device with a handle and a frame.

FIG. 2. shows a storage device with a frame.

FIG. 3. shows a storage device with a handle and no frame.

### DETAILED DESCRIPTION OF PREFERRED EMBODIMENTS OF THE INVENTION

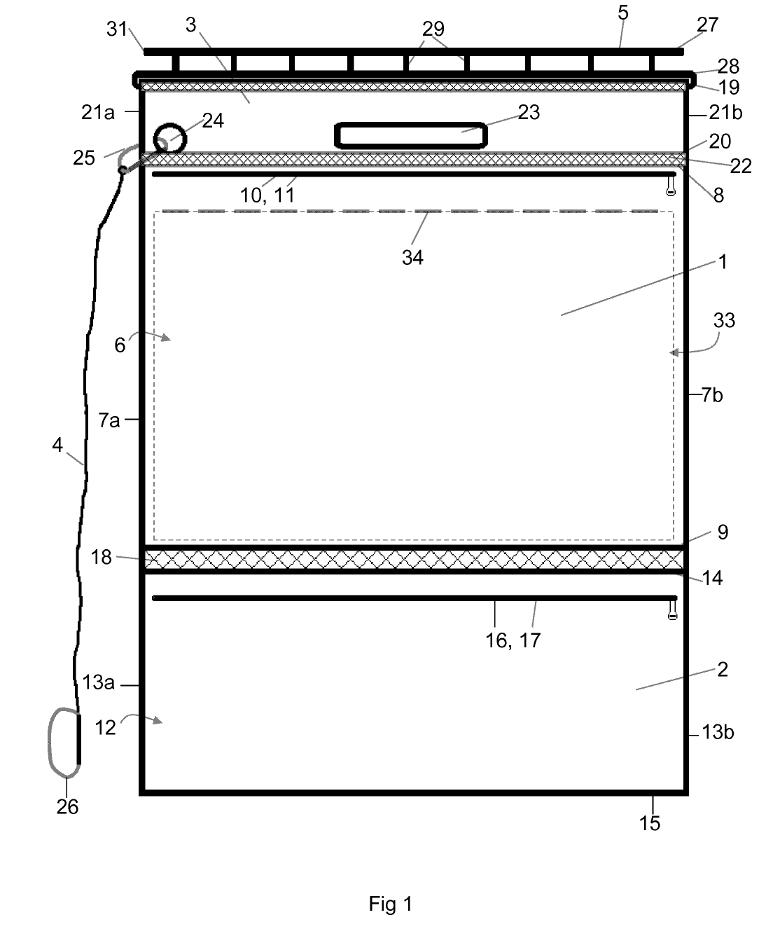

FIG. 1 shows the mobile storage device according to the present invention. The storage device comprises a first outer bag 1, which is attached to a second outer bag 2 and a handle part 3. A line 4 may be attached to the handle part 3. A frame 5 may also be present. Alternatively, the handle part 3 comprises the frame 5. The first outer bag 1 comprises a first cavity enclosed by a first front face 6 and a first back face (not shown). The first front and back faces are connected by side faces 7a and 7b. The side faces 7a, 7b are preferably the same to reduce manufacturing costs. A first width w1 of the first front face 6 and the first back face extends between the side faces 7a, 7b. The side faces 7a, 7b may be any attachment means, such as a zipper or a seam. The side faces 7a, 7b extend between a first upper side 8 and a first lower side 9.

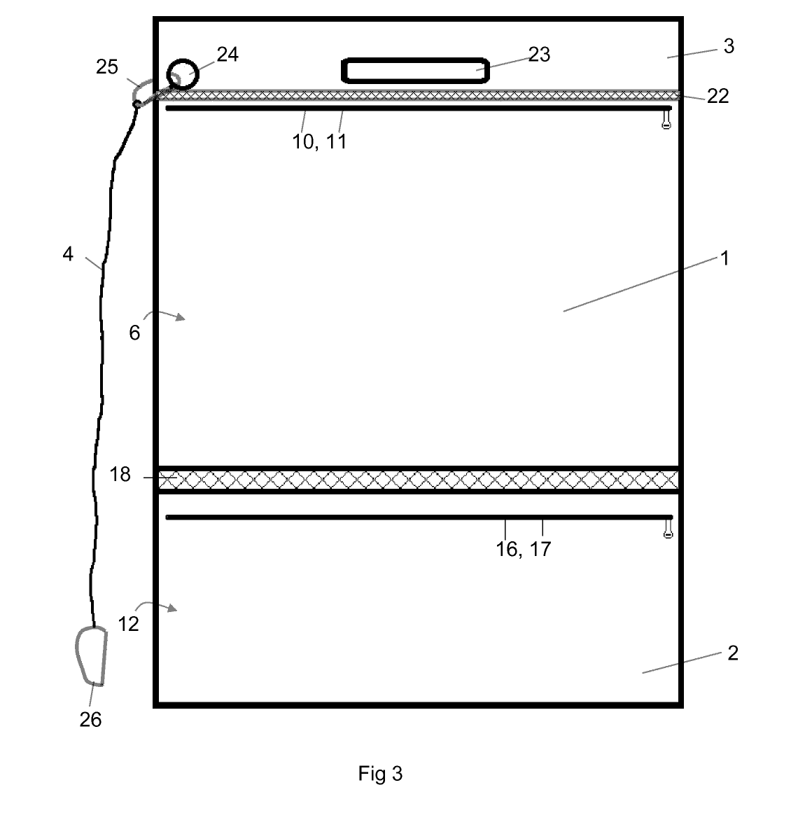

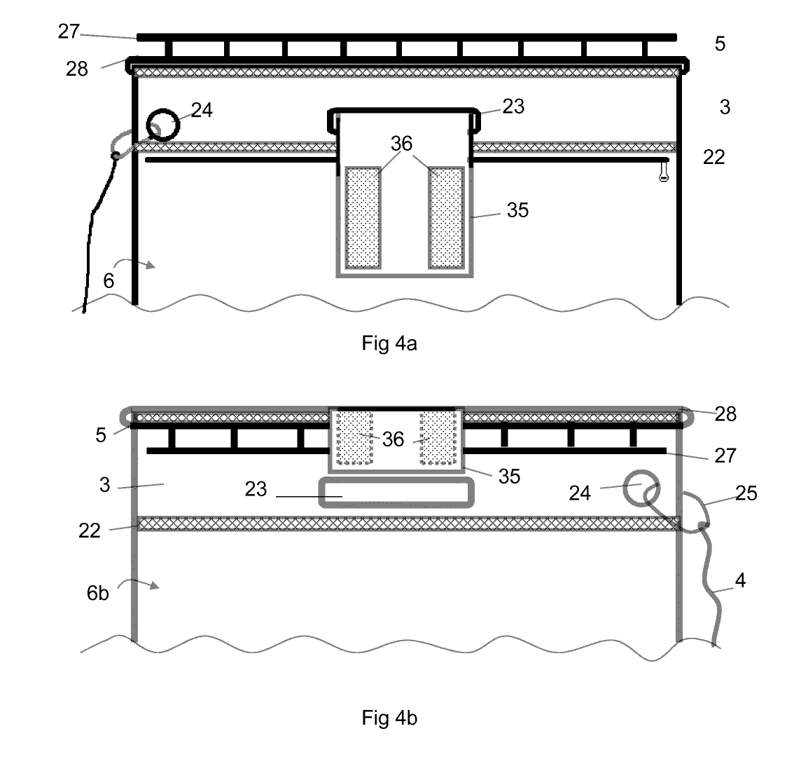

The first outer bag 1 comprises a first opening 10 positioned on the first front face 6. Preferably, the first opening 10 is position in the proximity of the first upper side 8 of the first outer bag 1 as shown in FIG. 1-3. The first opening 10 may extend parallel to the first upper side 8 of the first outer bag 1 over a portion, or 90% to 99% of the first width w1 of the first outer bag 1. The first opening 10 may at least partially be covered by a flap of material.

The first opening 10 can be opened and closed using a first locking member 11. This first locking member 11 may be any means able to close and open the first outer bag 1. Preferably, the first locking member 11 is easy to use and durable, even in wet conditions. Examples of locking member 11 may be a zipper, a zip-lock or a cord.

The first second outer bag 2 comprises a second cavity enclosed by a second front face 12 and a second back face (not shown). The second front and back faces are connected by side faces 13a, 13b. The side faces 13a, 13b are preferably the same to reduce manufacturing costs. A second width w2 of the second front face 12 and the second back face extends between the side faces 13a, 13b. The side faces 13a, 13b may be any attachment means such as a zipper or a seam. The side faces 13a, 13b extend between a second upper side 14 and a second lower side 15.

The second outer bag 2 comprises a second opening 16 positioned on the second front face 12. Preferably, the second opening 16 is position in the proximity of the second upper side 14 of the second outer bag 2 as shown in FIG. 1-3. The second opening 16 may extend parallel to the second upper side 14 of the second outer bag 2 over a portion, or 90% to 99% of the second width w2 of the second outer bag 2. The second opening 16 may at least partially be covered by a flap of material. The second width w2 of the second bag 2 is preferably the same as the first width w1 of the first outer bag 1.

The second opening 16 can be opened and closed using a second locking member 17. This second locking member 17 may be any means able to close and open the second outer bag 2. Preferably, the second locking member 17 is easy to use and durable, even in wet conditions. Examples of locking member 17 may be a zipper, a zip-lock or a cord. Preferably, the first locking member 11 and the second locking member 17 are the same.

The first outer bag 1 and the second outer bag 2 are attachable to each other such that the upper side 14 of the second outer bag 2 is attached to the lower side 9 of the first outer bag 1. This attachment 18 may be removable or not such that the second outer can be removed from the storage device. A cord or a zipper may be used to attach the first outer bag 1 and second outer bag 2. Alternatively, the two bags may be permanently attached to each other. The attachment 18 may be any attachment means 18 that firmly and durably attaches the bags together. In one embodiment, the attachment 18 comprises at least one seam.

The first outer bag 1 and the second outer bag 2 are preferably made of flexible, foldable and durable, tough material. In one embodiment, the bags 1, 2 are made of the same material. Examples of suitable materials are fabrics made of denier cordura or ballistic nylon, or x-pac, or recycled plastics, or canvas. The material or fabric used may be waterproof. In one embodiment, both outer bags 1, 2 are made of waterproof fabric. In another embodiment the first outer bag 1 is made of waterproof fabric and the second outer bag 2 is not made of waterproof material. The zippers, zip-locks and other locking member 11, 17 are preferably made of material that does not wear or rust, such as stainless steel or plastic. The weight of all materials used in the manufacturing of the storage device is preferably as light as possible.

The first outer bag 1 is configured to carry at least one food object. The second outer bag 2 is configured to carry at least one weight or load adapted to sink the storage device beneath a water level. The first outer bag 1 may be larger than the second outer bag 2.

The handle part 3 comprises an upper side 19 and a lower side 20, which are connected by two side walls 21a, 21b. The lower side 20 is attached to the first upper side 8 of the first outer bag 1. This attachment 22 is permanent and robust. Preferably, the attachment 22 contains at least one seam. The handle part 3 can be made of the same material as the first outer bag 1 and/or the second outer bag 2.

The handle part 3 comprises a first hole 23, which is adapted to enable a user to hold the device. This first hole 23 must be large enough for a hand of the user or at least four fingers to pass through the first hole 23. The first hole 23 is preferably positioned in the middle of the handle part 3 as shown in FIG. 1. The edge of the first hole 23 may be reinforced with at least one seam or a metal ring around the edge of the first hole 23.

The handle part 3 also comprises a second hole 24, which is adapted to connect the line 4 to the storage device. This second hole 24 may be smaller in size compared to the first hole 23. The size is preferably adapted to enable the use of a carbine. The second hole 24 is preferably positioned in the proximity of one of the side faces 21a, 21b of the handle part 3 as shown in FIG. 1. Alternatively, the handle part 3 may comprise two second holes 24. The edge of the second hole 24 may be reinforced with at least one seam or a metal ring around the edge of the second hole 24.

The line 4 may be any suitable wire member such as a rope or a cable. In one embodiment, the line is a rope. The line 4 comprises a first end and a second end. A first securing member 25 may be attached to the first end of the line 4 and a second securing member 26 may be attached to the second end of the line 4. The first securing member 25 is adapted to be connected to the handle part 3 using the second hole 24. Any securing means can be used for this purpose, for example a carbine may be used. The second securing member 26 is adapted to be attached to a holding object such as an object on shore or a boat or a buoy. The second securing member 26 may also be a carbine or any other securing means.

The line 4 may be made of any tough and durable material adapted for lowering and lifting the storage device, such as paracord, strong fishing line or other durable ropes or cords.

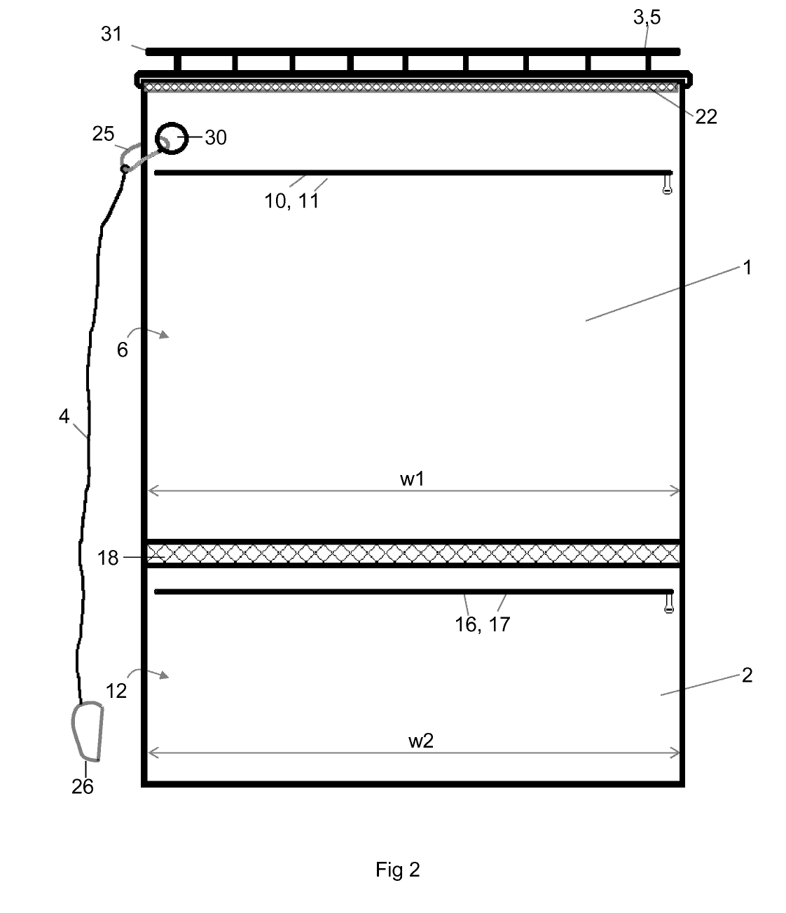

The storage device may further comprise a frame 5. In one embodiment as shown in FIG. 2 the handle part 3 is a frame 5. The frame 5 is firmly and permanently attached to the first upper side 8 of the first outer bag 1, or to the upper side 19 of the handle part 3. At least one seam may be used to attach the frame 5 to the storage device. The frame may comprise an upper side 27 and a lower side 28, whereby the lower side 27 is attached to the upper side 8, 19. The lower side 27 and upper side 28 extend parallel to the first upper side 8 of the first outer bag 1 and may be connected to each other by means of two or more separated parallel bars 30 extending between the lower side 27 and the upper side 28. The openings between the bars 29 provide for the first hole 23 and the second hole 24 of the handle part 3 if no separate handle part 3 is present in the storage device (FIG. 2). In this embodiment, an additional third hole 30 may optionally be present in the first outer bag 1 for attachment of the line 4 to the storage device as shown in FIG. 2. The frame is adapted for coiling of the line 4 on the frame 5. For this purpose the upper side 27 of the frame 5 preferably comprises protrusions 31 to hold the coiled line 4 on the frame 5. The frame may be made of light and durable material that is not sensitive to wear, such as rust. Suitable materials may be aluminum, titanium, stainless steel or plastics. Optionally, the frame 1 may include openings suitable for connection of the line 4.

The handle part 3 and the frame 5 have a width. The width of the handle part 3 and the width of the frame 5 are preferably the same as the first width w1 of the first outer bag 1 and the second width w2 of the second outer bag 2 as shown in FIG. 1.

At least one inner bag 33 (dotted line in FIG. 1) may be inserted in the first outer bag 1. The at least one inner bag 33 may be waterproof and adapted to hold at least one food object. An advantage of the use of at least one inner bag 33 is that food objects can be packed separately in the first outer bag 1. Another advantage is that the first outer bag 1 does not need to be made waterproof. The inner bag 33 comprises a locking member 34 adapted to seal the inner bag 33. This locking member 34 may be a zip-lock or any other lock. The inner bag 33 may be made of flexible plastic, preferably plastic that is waterproof and durable.

An isolation bag (not shown) may be used during transport of at least one food objects. For example, during transport to a camping side, food objects need to be cooled. For this purpose an isolation bag can be used. Such isolation bag may be made of plastic material and may comprise an aluminum lining to improve the cooling properties of the isolation bag.

The isolation bag may be inserted in the inner bag 33 or in the first outer bag 1. Also, the inner bag 33 may be inserted in the isolation bag and then inserted into the first outer bag 1. Ice blocks and the like may be used to improve the cooling during transport. These ice blocks may be inserted into any one of the first outer bag 1, the inner bag 32, or the isolation bag.

The storage device according to the present invention can be used for storing and/or cooling at least one food object or for freshness protection of at least one food object. For this purpose, the at least one food object is inserted in the first outer bag 1. The food object may be packed in at least one inner bag 33 before being inserted into the first outer bag 1. The second outer bag 2 is filled with at least one weight such as stones or sand. Both the first and second outer bags 1, 2, are locked and the line 4 is connected to the storage device using the second hole 24 or optionally the third hole 30.

The storage device is then submerged in the water of a lake or a sea at a depth between 0.01 and 25 metes. The second end of the line 4 is secured to a holding object such as a boat, a buoy or an object on shore. The depth can be varied by varying the length of the line 4. The part of the line 4 that is not used for lowering the storage device into the water can be coiled on the frame 5 or on the holding object. Alternatively, the storage device can be towed in the water for example when the boat is moving.

The water temperature decreases at increasing depth. The temperatures are different depending on the outer temperature and the depth of the lake or sea as well as the current in the water. Decreased temperatures are used for cooling the at least one food object comprised in the storage device.

The storage device can be retained from the depth by pulling the line 4 until the storage device surfaces. The storage device can than be held by the handle part 3 and pulled out of the water.

The term “comprises/comprising” when used in this specification is taken to specify the presence of stated features, integers, steps or components. However, the term does not preclude the presence or addition of at least one additional feature, integers, steps or components or groups thereof.

The present invention is not limited to the embodiments disclosed but may be varied and modified within the scope of the following claims.

1. A mobile device for storing and cooling food objects, comprising:
a first bag defining a first cavity configured to store at least one food object, and
a second bag attached to the first bag and defining a second cavity configured to store at least one weight for sinking the device below a water level,
characterized in that the first bag has an upper side and a lower side, the second bag has an upper side and a lower side, and the upper side of the second bag is attached to the lower side of the first bag, and the device further comprises an element designed to enable a line to be connected to the device for securing the device when the device is below the water level.

2. The mobile device according to claim 1, whereby the first bag and the second bag are made of flexible material.

3. The mobile device according to claim 1, whereby at least the first bag is made of a waterproof material.

4. The mobile device according to claim 1, whereby the device comprises a line configured to secure the storage device to a holding object, the line comprising a first securing member at a first end designed to be connected to the device and a second securing member at a second end for connecting to a holding element.

5. The mobile device according to claim 1, whereby said element comprises a hole.

6. The mobile device according to claim 1, whereby the device comprises a handle part having an upper side and a lower side and comprising a hole configured to enable a user to hold the storage device by a hand, the first bag has an upper side and a lower side, the lower side of the first bag is attached to the second bag, and the upper side of the first bag is attached to the lower side of the handle part.

7. The mobile device according to claim 5, whereby said hole configured to enable a line to be connected to the device is positioned in said handle part.

8. The mobile device according to claim 1, whereby the first bag comprising a first opening for receiving the food object and a first locking member configured to seal the first bag.

9. The mobile device according to claim 1, whereby the cavity of said first bag is enclosed by a first front face and a first back face, whereby the first front face and the first back face have a first width and are connected by side faces that extend between a first upper side and a first lower side of the first bag, and said first opening is positioned on the first front face extending over a portion of the first width.

10. The mobile device according to claim 1, whereby the second bag comprising a second opening for receiving the weight and a second locking member configured to seal the second outer bag.

11. The mobile device according to claim 9, whereby the cavity of said second bag is enclosed by a second front face and a second back face, whereby the second front face and the second back face have a second width and are connected by side faces that extend between a second upper side and a second lower side of the second bag, and said second opening is positioned on the second front face extending over a portion of the second width, whereby the first lower side of the first bag is attached to the second upper side of the second bag.

12. The mobile device according to claim 1, whereby the first and second bags are removably attached to each other.

13. The mobile device according to claim 1, whereby the device comprises at least one waterproof inner bag for storing at least one food object and adapted to be inserted inside the first bag, whereby the inner bag comprises a locking member configured to seal the inner bag.

14. (canceled)

15. A method for storing and cooling at least one food object by means of a storage device according to claim 1, comprising the steps of
filling the first bag with at least one food object,
filling the second bag with at least one weight,
attaching a first end of a line to said element of the storage device,
sinking the storage device below the water level, and
attaching a second end of the line to a holding object.

16. The mobile device according to claim 1, wherein said element is positioned above the upper side of the first bag.

17. The mobile device according to claim 6, whereby said hole configured to enable a line to be connected to the device is positioned in said handle part.

18. The mobile device according to claim 10, whereby the cavity of said second bag is enclosed by a second front face and a second back face, whereby the second front face and the second back face have a second width and are connected by side faces that extend between a second upper side and a second lower side of the second bag, and said second opening is positioned on the second front face extending over a portion of the second width, whereby the first lower side of the first bag is attached to the second upper side of the second bag.
